(19) United States
(12) Patent Application Publication
(10) Pub. No.: US 2022/0395042 A1
(43) Pub. Date: Dec. 15, 2022

(54) Face Masking Device And Method Of Use

(71) Applicant: Lewis Waites, Rowlett, TX (US)

(72) Inventor: Lewis Waites, Rowlett, TX (US)

(21) Appl. No.: 17/344,950

(22) Filed: Jun. 11, 2021

(51) Int. Cl. A41D 31/04; A41D 13/11; A62B 23/02

(52) U.S. Cl. CPC A41D 31/04; A41D 13/1161; A62B 23/025; A41D 2300/32; A41D 2400/36

(57) ABSTRACT

A face masking device for filtering air and infusing lavender thereinto includes a facemask, which is positionable on a face of a user. The facemask comprises a panel having a pair of straps engaged thereto and extending singly from opposed edges thereof. A pair of connectors is engaged singly to the straps distal from the panel. The connectors are selectively mutually couplable. The straps can be positioned around a head of the user, positioning the connectors to be mutually coupled so that the facemask is removably coupled to the head of the user with the panel positioned over a nose and mouth of the user. At least one of an aroma compound and an essential oil is infused into the panel. The panel filters particulates from air passing therethrough while releasing the at least one of the aroma compound and the essential oil into the air.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to masking devices and more particularly pertains to a new masking device for filtering air and infusing lavender thereinto. The present invention discloses a masking device comprising a lavender infused facemask having a conformable nose piece as well as hook and loop attachment straps.

### (2) Description of Related Art including information disclosed under 37 CFR 1.97 and 1.98.

The prior art relates to masking devices. Prior art masking devices may comprise scented facemasks. What is lacking in the prior art is a masking device comprising a lavender infused facemask having a conformable nose piece as well as hook and loop attachment straps.

### BRIEF SUMMARY OF THE INVENTION

An embodiment of the disclosure meets the needs presented above by generally comprising a facemask configured to be positioned on a face of a user so that the facemask is positioned over a mouth and a nose of the user. The facemask comprises a panel having a pair of straps engaged thereto and extending singly from opposed edges thereof. A pair of connectors is engaged singly to the straps distal from the panel. The connectors are selectively mutually couplable. The straps are configured to be positioned around a head of the user, positioning the connectors to be mutually coupled so that the facemask is removably coupled to the head of the user. The panel thus is configured to filter particulates from air passing therethrough. At least one of an aroma compound and an essential oil is infused into the panel. The panel is configured to release the at least one of the aroma compound and the essential oil into the air passing therethrough.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a face masking device according to an embodiment of the disclosure.

FIG. 2 is a front view of an embodiment of the disclosure.

FIG. 3 is a back view of an embodiment of the disclosure.

FIG. 4 is an in-use view of an embodiment of the disclosure.

FIG. 5 is a cross-sectional view of an embodiment of the disclosure.

FIG. 6 is a front view of an embodiment of the disclosure.

FIG. 7 is a flow diagram for a method utilizing an embodiment of the disclosure.

### DETAILED DESCRIPTION OF THE INVENTION

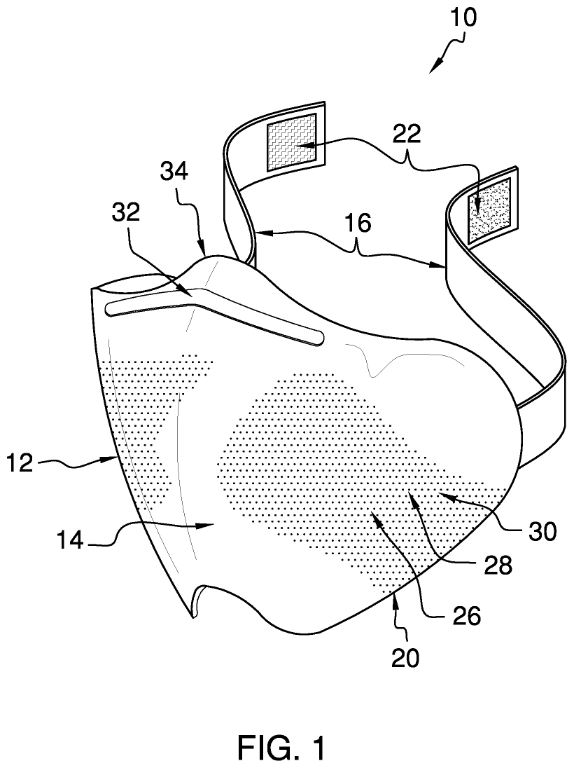

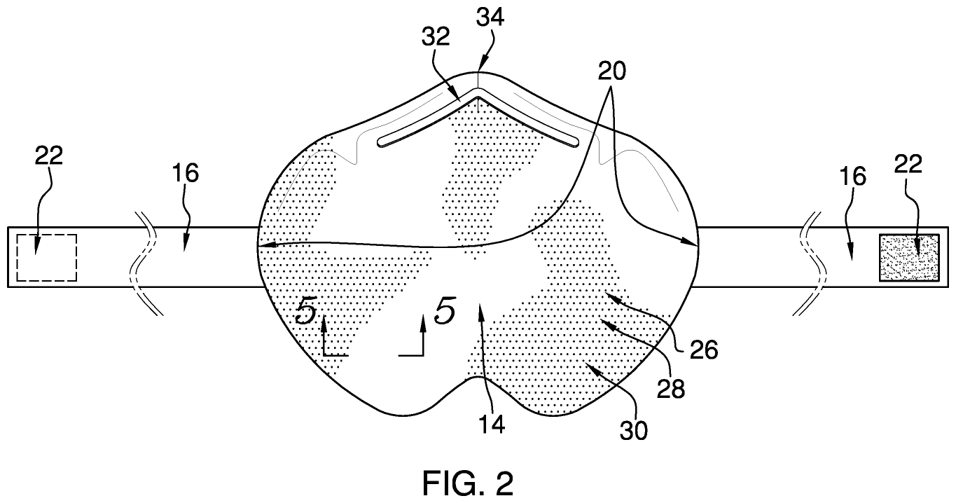

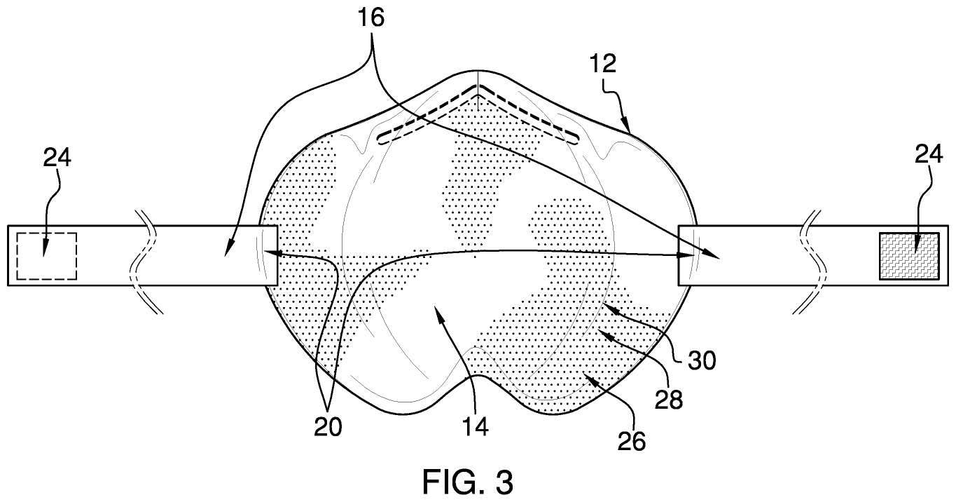

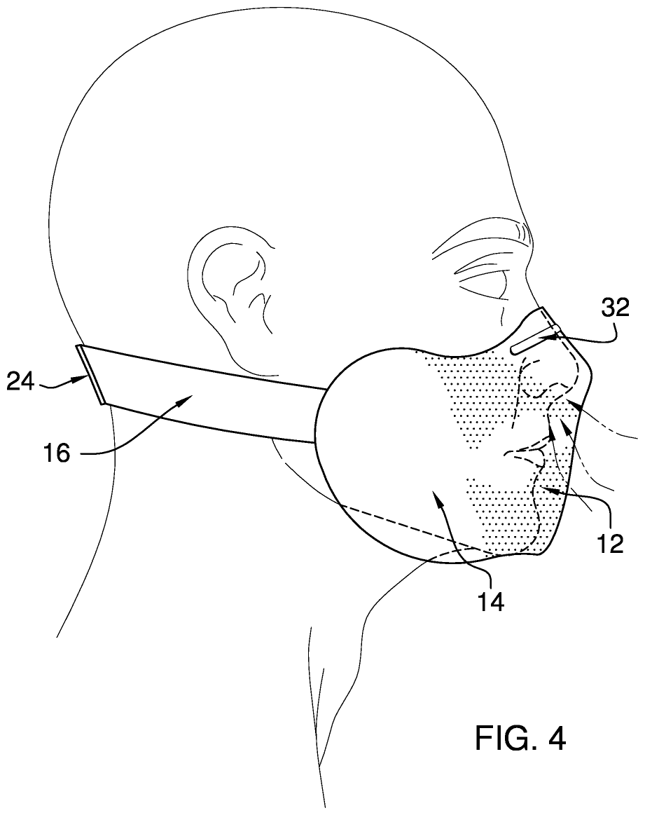

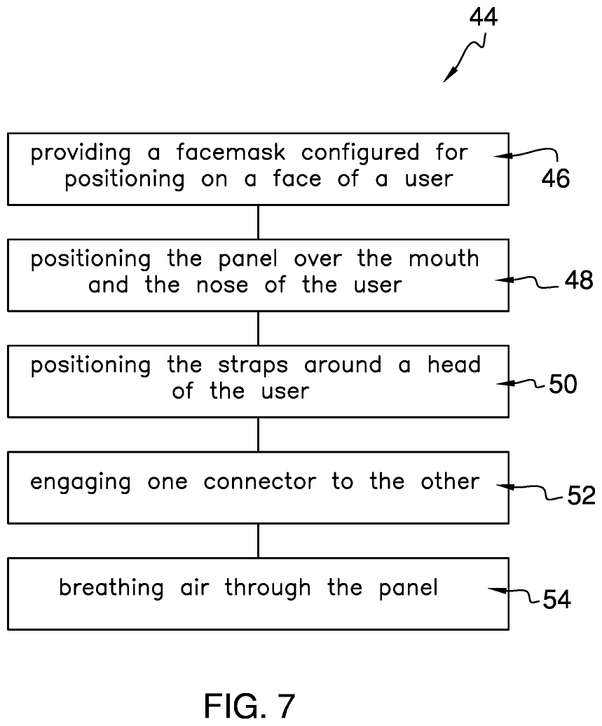

With reference now to the drawings, and in particular to FIGS. 1 through 7 thereof, a new masking device embodying the principles and concepts of an embodiment of the disclosure and generally designated by the reference numeral 10 will be described.

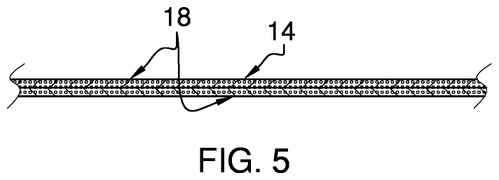

As best illustrated in FIGS. 1 through 7, the face masking device 10 generally comprises a facemask 12 configured to be positioned on a face of a user. The facemask 12 comprises a panel 14 and a pair of straps 16. The panel 14 in turn comprises a plurality of layers 18, such as, for example, two layers 18, as shown in FIG. 5. As will become apparent, the panel 14 comprising multiple layers 18 improves filtration of particulates from air passing through the panel 14. The panel 14 may comprise cloth, or other material or combination of materials, such as, but not limited to, gauze, cellulose, and polypropylene.

The straps 16 are engaged to and extend singly from opposed edges 20 of the panel 14. A pair of connectors 22 is engaged singly to the straps 16 distal from the panel 14. The connectors 22 are selectively mutually couplable. The pair of connectors 22 may comprise a hook and loop fastener 24, as shown in FIG. 1, or other connecting means, such as, but not limited to, buckles, snap closures, button closures, and the like.

The straps 16 are configured to be positioned around a head of the user, positioning the connectors 22 to be mutually coupled. The facemask 12 thus is removably coupled to the head of the user, with the panel 12 positioned over a nose and mouth of the user.

The straps 16 of the pair of straps 16 may be substantially length equivalent, as shown in FIG. 1. With the straps 16 being substantially length equivalent, the hook and loop fastener 24 is positioned on a back of the head of the user. The present invention also anticipates the straps 16 being non-length equivalent, which would position the hook and loop fastener 24 on a side of the head of the user.

The straps 16 comprises elastic so that the straps 16 are resiliently stretchable. The straps 16 being resiliently stretchable facilitates a tight fit of the panel 14 over the nose and the mouth of the user.

At least one of an aroma compound 26 and an essential oil 28 is infused into the panel 14. The panel 14 thus is configured to filter particulates from, and to release the at least one of the aroma compound 26 and the essential oil 28 into, air passing therethrough. The at least one of an aroma compound 26 and an essential oil 28 may comprise lavender oil 30.

The present invention is anticipated to be useful in filtering particulates from air breathed by a user, such as dust, bacteria, and viruses. Additionally, the panel 14 provides protection to the user and to persons proximate to the user by stopping aerosols and droplets, which can contain bacteria and viruses. Another anticipated benefit of the device 10 is effected by the lavender oil 30, which promotes relaxation and is postulated to treat anxiety. Many people become anxious when required to mask, and this anxiety can be relieved by treatment with lavender oil 30.

A strip 32 is engaged to the panel 14 proximate to an upper edge 34 thereof and substantially equally distant from the opposed edges 20. The strip 32 comprises metal and is resiliently bendable so that the strip 32 is conformable to a bridge of the nose of the user, facilitating a tight fit of the panel 14 thereto.

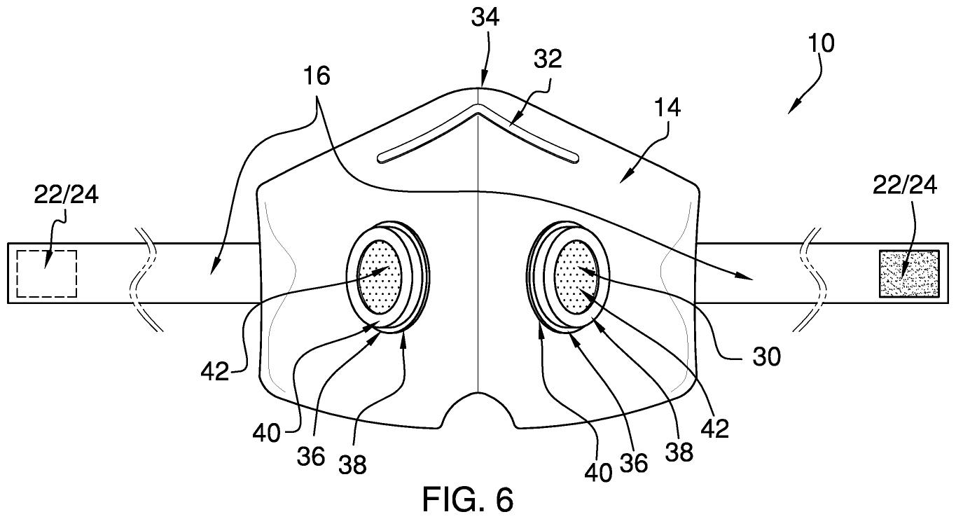

As shown in FIG. 6, the panel 14 may have an orifice 36 positioned therein. A first ring 38, which is internally threaded, is engaged to the panel 14 and positioned in the orifice 36. A second ring 40, which is externally threaded, is complementary to and positioned to be selectively threadedly engaged to the first ring 38. A filter 42 engaged to the second ring 40 is infused with the at least one of an aroma compound 26 and an essential oil 28. When the filter 42 becomes clogged or the at least one of an aroma compound 26 and an essential oil 28 is exhausted, the filter 42 can be replaced.

The device 10 enables a method 44 of filtering air and infusing at least one of an aroma compound 26 and an essential oil 28 thereinto. The method 44 comprises a first step 46 of providing a facemask 12, per the specification above, and comprising a panel 14 infused with the at least one of an aroma compound 26 and an essential oil 28.

A second step 48 of the method 44 entails positioning the panel 14 over the mouth and the nose of the user. A third step 50 of the method 44 entails positioning the straps 16 around a head of the user so that the connectors 22 are positioned to be mutually coupled. A fourth step 52 of the method 44 requires engaging one connector 22 to the other connector 22 so that the facemask 12 is removably coupled to the head of the user. A fifth step 54 of the method 44 is breathing air through the panel 14. The panel 14 filters particulates from air passing therethrough while releasing the at least one of the aroma compound 26 and the essential oil 28 into the air.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A face masking device comprising a facemask configured for positioning on a face of a user, the facemask comprising:
a panel;
a pair of straps engaged to and extending singly from opposed edges of the panel;
a pair of connectors engaged singly to the straps distal from the panel, the connectors being selectively mutually couplable, wherein the straps are configured for positioning around a head of the user, positioning the connectors for mutually coupling, such that the facemask is removably coupled to the head of the user with the panel positioned over a nose and mouth of the user, wherein the panel is configured for filtering particulates from air passing therethrough; and
at least one of an aroma compound and an essential oil infused into the panel, wherein the panel is configured for releasing the at least one of the aroma compound and the essential oil into the air passing therethrough.

2. The face masking device of claim 1, wherein the panel comprises cloth.

3. The face masking device of claim 1, wherein the panel comprises a plurality of layers.

4. The face masking device of claim 1, wherein the straps of the pair of straps are substantially length equivalent.

5. The face masking device of claim 1, wherein the straps comprise elastic, such that the straps are resiliently stretchable.

6. The face masking device of claim 1, wherein the pair of connectors comprises a hook and loop fastener.

7. The face masking device of claim 1, wherein the at least one of an aroma compound and an essential oil comprises lavender oil.

8. The face masking device of claim 1, further including a strip engaged to the panel, proximate to an upper edge thereof and substantially equally distant from the opposed edges, the strip being resiliently bendable, such that the strip is conformable to a bridge of the nose of the user.

9. The face masking device of claim 8, wherein the strip comprises metal.

10. The face masking device of claim 1, further including:
the panel having an orifice positioned therein;
a first ring engaged to the panel and positioned in the orifice, the first ring being internally threaded;
a second ring, the second ring being externally threaded, such that the second ring is complementary to and positioned for selectively threadedly engaging the first ring; and
a filter engaged to the second ring, the at least one of an aroma compound and an essential oil being infused into the filter.

11. A method of filtering air and infusing at least one of an aroma compound and an essential oil thereinto, the method comprising the steps of:
providing a facemask configured for positioning on a face of a user, the facemask comprising:
a panel,
a pair of straps engaged to and extending singly from opposed edges of the panel,
a pair of connectors engaged singly to the straps distal from the panel, the connectors being selectively mutually couplable, and
at least one of an aroma compound and an essential oil infused into the panel;
positioning the panel over the mouth and the nose of the user;
positioning the straps around a head of the user, such that the connectors are positioned for being mutually coupled;
engaging one connector to the other such that the facemask is removably coupled to the head of the user; and
breathing air through the panel, wherein the panel is configured for filtering particulates from air passing therethrough and for releasing the at least one of the aroma compound and the essential oil thereinto.

12. A face masking device comprising a facemask configured for positioning on a face of a user, the facemask comprising:
a panel, the panel comprising cloth, the panel comprising a plurality of layers;
a pair of straps engaged to and extending singly from opposed edges of the panel, the straps of the pair of straps being substantially length equivalent, the straps comprising elastic, such that the straps are resiliently stretchable;
a pair of connectors engaged singly to the straps distal from the panel, the connectors being selectively mutually couplable, wherein the straps are configured for positioning around a head of the user, positioning the connectors for mutually coupling, such that the facemask is removably coupled to the head of the user with the panel positioned over a nose and mouth of the user, wherein the panel is configured for filtering particulates from air passing therethrough, the pair of connectors comprising a hook and loop fastener;
at least one of an aroma compound and an essential oil infused into the panel, wherein the panel is configured for releasing the at least one of the aroma compound and the essential oil into the air passing therethrough, the at least one of an aroma compound and an essential oil comprising lavender oil; and
a strip engaged to the panel, proximate to an upper edge thereof and substantially equally distant from the opposed edges, the strip being resiliently bendable, such that the strip is conformable to a bridge of the nose of the user, the strip comprising metal.

13. The face masking device of claim 12, further including:
the panel having an orifice positioned therein;
a first ring engaged to the panel and positioned in the orifice, the first ring being internally threaded;
a second ring, the second ring being externally threaded, such that the second ring is complementary to and positioned for selectively threadedly engaging the first ring; and
a filter engaged to the second ring, the at least one of an aroma compound and an essential oil being infused into the filter.
